(19) United States
(12) Patent Application Publication
(10) Pub. No.: US 2025/0279494 A1
(43) Pub. Date: Sep. 4, 2025

(54) BATTERY PACK LIQUID COOLANT GUIDES AND METHOD OF GUIDING LIQUID COOLANT

(71) Applicant: Ford Global Technologies, LLC, Dearborn, MI (US)

(72) Inventor: Jie Deng, Novi, MI (US)

(21) Appl. No.: 18/594,174

(22) Filed: Mar. 4, 2024

(51) Int. Cl. H01M 10/625; B60L 50/60; B60L 58/26; H01M 10/613; H01M 10/6551; H01M 10/6567; H01M 50/211; H01M 50/289

(52) U.S. Cl. CPC H01M 10/625; B60L 50/60; B60L 58/26; H01M 10/613; H01M 10/6551; H01M 10/6567; H01M 50/211; H01M 50/289; H01M 2220/20

(57) ABSTRACT

A traction battery pack assembly includes a plurality of battery cell groups disposed along a cell stack axis of a cell stack. Each of the battery cell groups includes at least one battery cell. A plurality of liquid guides are configured to guide a liquid coolant axially between the battery cell groups. The battery cell groups are separated from each other by at least some of the liquid guides within the plurality of liquid guides.

### TECHNICAL FIELD

This disclosure details exemplary systems that guide liquid coolant within a battery pack and, more particularly, to a system that guides the liquid coolant between cells of a cell stack.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. As part of an immersion thermal management system, liquid coolant can be moved through the traction battery pack to help manage thermal energy within the traction battery pack.

### SUMMARY

In some aspects, the techniques described herein relate to a traction battery pack assembly, including: a plurality of battery cell groups disposed along a cell stack axis of a cell stack, each of the battery cell groups including at least one battery cell; and a plurality of liquid guides configured to guide a liquid coolant axially between the battery cell groups, the plurality of battery cell groups separated from each other by at least some of the liquid guides within the plurality of liquid guides.

In some aspects, the techniques described herein relate to an assembly, further including a plurality of liquid channels between axially adjacent battery cell groups within the plurality of battery cells.

In some aspects, the techniques described herein relate to an assembly, further including a plurality of thermal fins, the plurality of battery cell groups separated from each other by at least one of the battery cell groups.

In some aspects, the techniques described herein relate to an assembly, further including a plurality of liquid channels between axially adjacent battery cell groups within the plurality of battery cells.

In some aspects, the techniques described herein relate to an assembly, wherein the liquid channels each have a circumferential perimeter established entirely by some of the liquid guides within the plurality of liquid guides and some of the thermal fins within the plurality of thermal fins.

In some aspects, the techniques described herein relate to an assembly, wherein the thermal fins within the plurality of thermal fins are a metal or metal alloy.

In some aspects, the techniques described herein relate to an assembly, wherein the liquid guides are each sandwiched between two of the thermal fins within the plurality of thermal fins.

In some aspects, the techniques described herein relate to an assembly, wherein the liquid guides are compressible.

In some aspects, the techniques described herein relate to an assembly, wherein the liquid guides are foam.

In some aspects, the techniques described herein relate to an assembly, wherein the liquid guides are strips that extend from a position adjacent a top side of the cell stack to a position adjacent a bottom side of the cell stack.

In some aspects, the techniques described herein relate to an assembly, wherein the liquid guides are configured to guide the liquid coolant at a position between axially adjacent battery cells within the plurality of battery cells.

In some aspects, the techniques described herein relate to an assembly, further including a plurality of stand-offs that maintain a spacing between an enclosure and the plurality of battery cells, the spacing configured to communicate the liquid coolant.

In some aspects, the techniques described herein relate to an assembly, further including the enclosure, the plurality of stand-offs provided by dimples within the enclosure.

In some aspects, the techniques described herein relate to an assembly, wherein the plurality of stand-offs include some of the stand-offs within the plurality of stand-offs vertically beneath the plurality of battery cells and some of the stand-offs within the plurality of stand-offs vertically above the plurality of battery cells.

In some aspects, the techniques described herein relate to an assembly, wherein the liquid coolant is a dielectric liquid coolant.

In some aspects, the techniques described herein relate to a method of managing thermal energy levels within a traction battery pack, including: immersing at least a portion of a cell stack within a liquid coolant to manage thermal energy within the cell stack, the cell stack including a plurality of battery cells disposed along a cell stack axis; and guiding the liquid coolant through liquid channels that are axially between groups of the battery cells of the cell stack, the groups spaced axially from each other by a plurality of liquid guides.

In some aspects, the techniques described herein relate to a method, wherein the plurality of liquid guides are configured to compress in response to expansion of the battery cells along the cell stack axis.

In some aspects, the techniques described herein relate to a method, further including spacing the cell stack away from an enclosure using a plurality of stand-offs, the spacing providing an area for the liquid coolant to move above the cell stack, beneath the cell stack, or both.

In some aspects, the techniques described herein relate to a method, wherein the plurality of stand-offs are stamped in the enclosure.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack.

FIG. 2 illustrates a perspective view of the battery pack of FIG. 1 along with portions of an immersion thermal management system.

FIG. 3 illustrates an expanded view of the battery pack of FIG. 2.

FIG. 4 illustrates a close up view of an area in FIG. 3.

FIG. 5 illustrates a section view taken at line 5-5 in FIG. 2.

### DETAILED DESCRIPTION

An immersion thermal management system can be used to manage thermal energy in a traction battery pack. The immersion thermal management system immerses at least some components of the traction battery pack in a liquid coolant. The immersed components can include a cell stack. This disclosure is directed toward guiding the liquid coolant between cells of the cell stack.

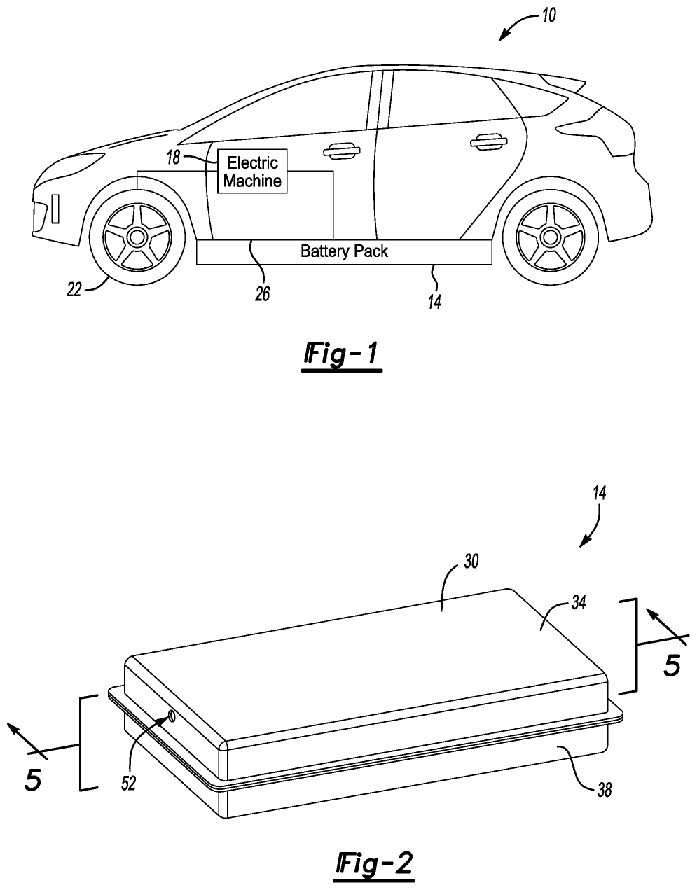

With reference to FIG. 1, an electrified vehicle 10 includes a traction battery pack 14, an electric machine 18, and wheels 22. The traction battery pack 14 powers an electric machine 18, which can convert electrical power to mechanical power to drive the wheels 22. The traction battery pack 14 can be a relatively high-voltage battery.

The traction battery pack 14 is, in the exemplary embodiment, secured to an underbody 26 of the electrified vehicle 10. The traction battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

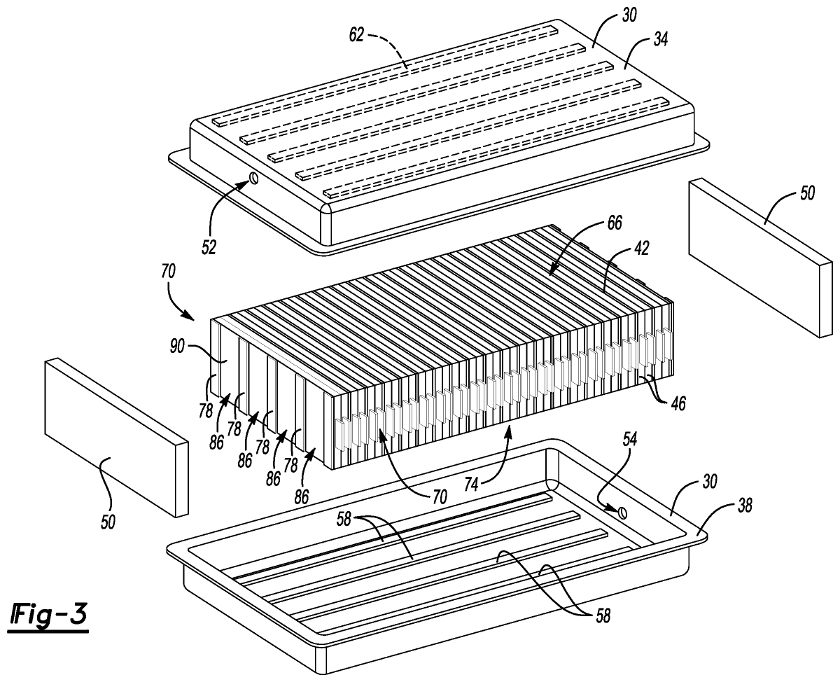

FIG. 2 illustrates additional detail of the example battery pack 14. In this example, the battery pack 14 includes an enclosure assembly 30. The enclosure assembly 30 includes a cover 34 and a tray 38. The cover 34, in this example, is vertically above the tray 38. In other examples, however, the cover 34 could be arranged below, or to a side of the tray 38. Various terms such as “above,” “below,” “top,” and “bottom” are used relative to the arrangement of the components of the battery pack 14 in the various drawings and should not otherwise be deemed limiting. These terms are with reference to the general orientation of the battery pack 14 when installed within the vehicle 10 of FIG. 1,

The cover 34 is welded to the tray 38 in one example of this disclosure. While welding is mentioned, the cover 34 and tray 38 could be connected using other fluid-tight connection techniques, such as adhesive. Further, while an exemplary enclosure assembly 30 is shown in the drawings, the enclosure assembly 30 may vary in size, shape, and configuration within the scope of this disclosure.

In this disclosure, a cell stack 42 is arranged within the enclosure assembly 30. The cell stack 42 includes a plurality of individual battery cells 46 disposed along a cell stack axis A between a pair of endplates 50. The cell stack 42 could include any number of battery cells 46. The battery pack 14 could employ any number of cell stacks 42 within the enclosure assembly 30. Thus, this disclosure is not limited to the exact configuration shown in FIG. 2. Further, while the battery cells 46 of FIG. 2 are positioned side-by-side relative to one another, other configurations are also contemplated within the scope of this disclosure, including but not limited to embodiments in which the battery cells 46 are stacked on top of one another, for example.

In an embodiment, the battery cells 46 are lithium-ion pouch cells. However, battery cells having other geometries (cylindrical, etc.), other chemistries (nickel-metal hydride, lead-acid, etc.), or both could alternatively be utilized within the scope of this disclosure.

The cell stack 42 is arranged in an interior of the enclosure assembly 30 within the tray 38 and beneath the cover 34. A thermal management system is used to manage thermal energy levels within the battery pack 14. The example thermal management system is configured to route non-conductive (i.e., dielectric) liquid coolant C over areas of the cell stack 42 to manage thermal energy within the cell stack 42 by, for example, using the coolant C to take on heat from the cell stack 42. the thermal management system is an immersion thermal management system at least because portions of the battery pack 14, here at least the battery cells 46 of the cell stack 42 are immersed in the coolant C.

In this example, the coolant C generally flows from an inlet 52, which is formed in the cover 34, to an outlet 54, which is formed in the tray 38 at an opposite end of the enclosure assembly 30 from the inlet 52. The cell stack 42 is spaced from portions of the tray 38 with at least one stand-off 58. The cell stack 42 is spaced from portions of the cover 34 with at least one stand-off 62. The spacing provided by the stand-offs 58 and 62 provides areas for the coolant C to move to the outlet 54 above the cell stack 42 and beneath the cell stack 42.

In this example, the cover 34 and the tray 38 are metal or metal alloys. The stand-offs 58 and 62 can be, for example, dimples that are stamped in the cover 34 and the tray 38, respectively. In another example, the stand-offs 58 and 62 are separate pieces, such as foam strips, that are adhered to the cover 34 and the tray 38.

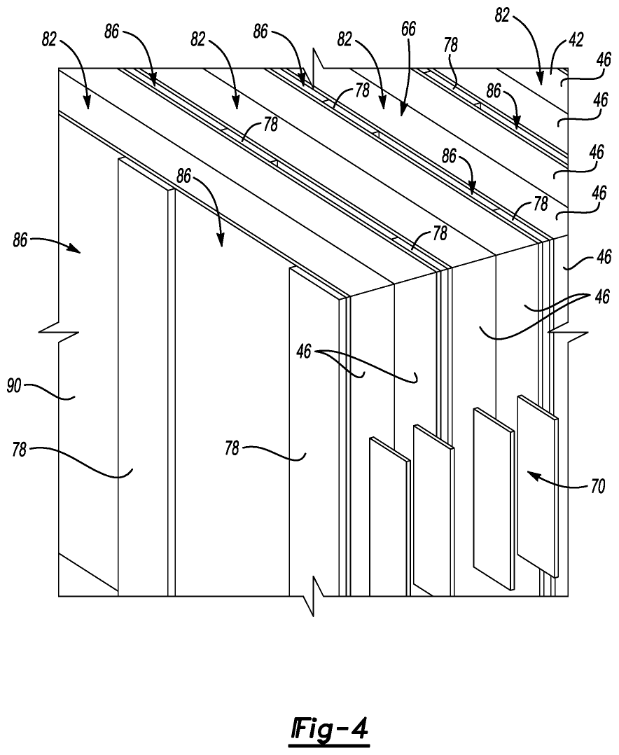

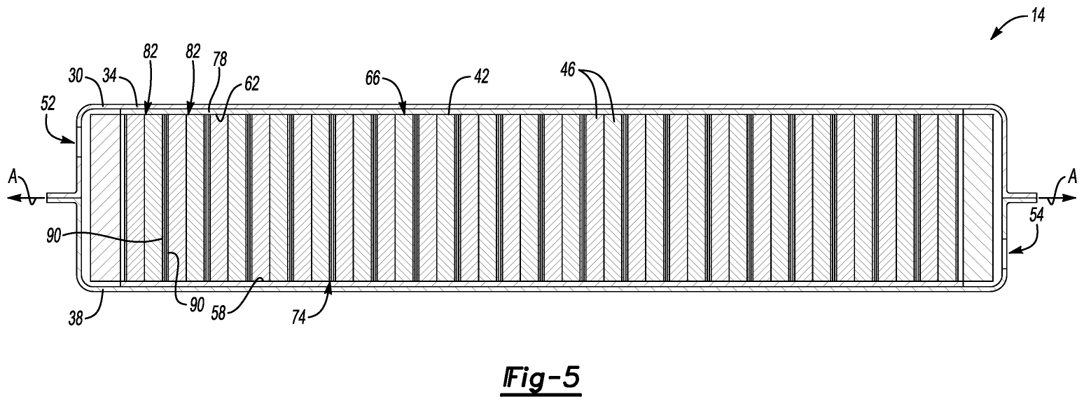

With reference now to FIGS. 3-5, the cell stack 42 has a top side 66, opposing outboard sides 70, and a bottom side 74. Within the interior of the enclosure assembly 30, some of the coolant C moves from the cover 34 through the top side 66 of the cell stack 42 and in between the cells 46. Thermal energy can transfer between the coolant and the cells 46 as the coolant C moves between the cells 46. As can be appreciated, increasing a surface area of the cells 46 contacting the coolant C can facilitate thermal energy transfer.

To maintain spacing for the coolant to move through the cell stack 42, the cell stack 42 incorporates a plurality of liquid guides 78 that keeps groups 82 of the cells 46 spaced from each other to establish liquid channels 86 between the groups 82 of the cells 46. The coolant C can communicate vertically downward through the cells stack 42 within the liquid channels 86 that provides clearance between the cells 46 for the coolant C to move between the cells 46.

In this example, the groups 82 each include two of the cells 46. In other examples, other numbers of cells 46 could be included in the groups 82-the groups 82 could even each include one cell 46. Each of the groups 82 is spaced from the axially adjacent groups 82 by five of the liquid guides 78 to establish four liquid channels 86 between each of the axially adjacent groups 82 within the cells stack 42. Additional liquid guides 78 are sandwiched between each endplate 50 and groups 82 of the cells 46 to establish liquid channels 86 at the axial ends of the cell stack 42.

The liquid guides 78 are strips that extend from a position adjacent the top side 66 to the of the cell stack 42 to the bottom side 74 of the cell stack 42.

The liquid guides 78 are compressible in this example. The liquid guides 78 can be foam, aerogel, or both. During operation, should cells 46 expand along the cell stack axis A, the liquid guides 78 can, in response, be compressed to accommodate expansion of the cells 46.

The cell stack 42 includes a plurality of thermal fins 90. In this example, each of the cells 46 interfaces directly with one of the thermal fins 90. The liquid guides 78 are each sandwiched between two of the thermal fins 90. The thermal fins 90 can facilitate pressure uniformity when compressing the liquid guides 78 due to expansion of one or more of the cells 46 along the axis A. The thermal fins 90 can facilitate thermal transfer to the liquid within the liquid channels 86. The thermal fins 90 can provide a physical barrier to block particulates vented out from the cells 46 during thermal propagation.

As the thermal fins 90 sandwich the liquid guides 78, the liquid channels 86 of the exemplary embodiment each have a circumferential perimeter established entirely by two of the liquid guides 78 and two of the thermal fins 90.

Features of disclosed examples include a system that provides space for flow between cells, and that guides flow moving between cells.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
a plurality of battery cell groups disposed along a cell stack axis of a cell stack, each of the battery cell groups including at least one battery cell; and
a plurality of liquid guides configured to guide a liquid coolant axially between the battery cell groups, the plurality of battery cell groups separated from each other by at least some of the liquid guides within the plurality of liquid guides.

2. The assembly of claim 1, further comprising a plurality of liquid channels between axially adjacent battery cell groups within the plurality of battery cells.

3. The assembly of claim 1, further comprising a plurality of thermal fins, the plurality of battery cell groups separated from each other by at least one of the battery cell groups.

4. The assembly of claim 3, further comprising a plurality of liquid channels between axially adjacent battery cell groups within the plurality of battery cells.

5. The assembly of claim 4, wherein the liquid channels each have a circumferential perimeter established entirely by some of the liquid guides within the plurality of liquid guides and some of the thermal fins within the plurality of thermal fins.

6. The assembly of claim 3, wherein the thermal fins within the plurality of thermal fins are a metal or metal alloy.

7. The assembly of claim 3, wherein the liquid guides are each sandwiched between two of the thermal fins within the plurality of thermal fins.

8. The assembly of claim 1, wherein the liquid guides are compressible.

9. The assembly of claim 1, wherein the liquid guides are foam.

10. The assembly of claim 1, wherein the liquid guides are strips that extend from a position adjacent a top side of the cell stack to a position adjacent a bottom side of the cell stack.

11. The assembly of claim 1, wherein the liquid guides are configured to guide the liquid coolant at a position between axially adjacent battery cells within the plurality of battery cells.

12. The assembly of claim 1, further comprising a plurality of stand-offs that maintain a spacing between an enclosure and the plurality of battery cells, the spacing configured to communicate the liquid coolant.

13. The assembly of claim 12, further comprising the enclosure, the plurality of stand-offs provided by dimples within the enclosure.

14. The assembly of claim 13, wherein the plurality of stand-offs include some of the stand-offs within the plurality of stand-offs vertically beneath the plurality of battery cells and some of the stand-offs within the plurality of stand-offs vertically above the plurality of battery cells.

15. The assembly of claim 1, wherein the liquid coolant is a dielectric liquid coolant.

16. A method of managing thermal energy levels within a traction battery pack, comprising:
immersing at least a portion of a cell stack within a liquid coolant to manage thermal energy within the cell stack, the cell stack including a plurality of battery cells disposed along a cell stack axis; and
guiding the liquid coolant through liquid channels that are axially between groups of the battery cells of the cell stack, the groups spaced axially from each other by a plurality of liquid guides.

17. The method of claim 16, wherein the plurality of liquid guides are configured to compress in response to expansion of the battery cells along the cell stack axis.

18. The method of claim 16, further comprising spacing the cell stack away from an enclosure using a plurality of stand-offs, the spacing providing an area for the liquid coolant to move above the cell stack, beneath the cell stack, or both.

19. The method of claim 18, wherein the plurality of stand-offs are stamped in the enclosure.
